(19) United States
(12) Patent Application Publication
(10) Pub. No.: US 2006/0072973 A1
(43) Pub. Date: Apr. 6, 2006

(54) External bead trimmer with a shaving breaker device

(75) Inventor: Luciano Micali, Guastalla (IT)

Correspondence Address: YOUNG & THOMPSON, 745 SOUTH 23RD STREET, 2ND FLOOR, ARLINGTON, VA, 22202, US

(73) Assignee: OTO Mills S.P.A, Boretto (REGGIO EMILIA) (IT)

(21) Appl. No.: 10/536,724

(22) PCT Filed: May 26, 2004
(86) PCT No.: PCT/IT04/00304

§ 371 Date: May 27, 2005

(30) Foreign Application Priority Data
Jul. 22, 2003 (IT) MO2003A000208

(51) Int. Cl. B23P 15/28

(52) U.S. Cl. 407/2

(57) ABSTRACT

The bead-trimmer with a shaving breaker device includes a support (2) having at an end thereof a through-hole (3) which bears, on an entrance edge thereof a cutting element (4) arranged and conformed to remove, during a cutting motion, an external weld bead (20) and to direct a resulting shaving (21) through the through-hole (3), the through-hole (3) bearing, in proximity of an exit edge thereof, elements for chopping (5) the shaving, predisposed to fragment the shaving coming from the through-hole (3).

### TECHNICAL FIELD

The invention belongs to the field of bead trimmers, and includes a breaker device for the bead shavings.

### BACKGROUND ART

The prior art includes external bead trimmers in machines predisposed on continuous production lines for elements which are longitudinally welded. These machines, equipped with a trimming tool, remove from the outside surface of the elements excess bead from the longitudinal weld seam. The tool is placed in contact with the weld bead of the elements, which run longitudinally and continuously. The bead is removed continuously from the elements, with the bead becoming a shaving which flows more or less continuously, depending on the material being treated and the cutting parameters; whence it forms hanks of shaved beads.

The hanks are generally taken to a pressing system or a chopping group in the vicinity of the machine. Alternatively, in some cases, the shaving are removed and wound up to form an ordered hank.

The prior art exhibits some drawbacks. The variability of the flow of shaving and the tendency the shavings have to coil up into a shapeless hank necessitate the constant presence of an operative who, using special metal hooks, drives the material towards the pressing system. If the shavings are wound continuously into an ordered hank, when the bead breaks, as is frequent, the operative must hook up the lengths of shaving to the hank so that the continuity is not lost. In both cases the operative is working in conditions of a certain level of risk in as much as the shavings are sharp and rather hot, i.e. at a temperature of not less than 300° C. The operative's presence is also necessary for removing the pressed hank.

The main aim of the present invention is to obviate the drawbacks in the prior art. An advantage of the present invention is that it enables a completely automatic management of the shavings coming from the bead trimmer.

A further advantage of the invention is that the treated shavings have a simple and easy shape to manage, so the manual operations required are minimal. A further advantage of the invention is that it is perfectly suited to high-speed production cycles.

### DISCLOSURE OF INVENTION

Further characteristics and advantages of the present invention will better emerge from the detailed description that follows of a preferred but non-exclusive embodiment of a bead trimming machine with a shaving breaker device, illustrated purely by way of a non-limiting example in the accompanying figures of the drawings, in which:

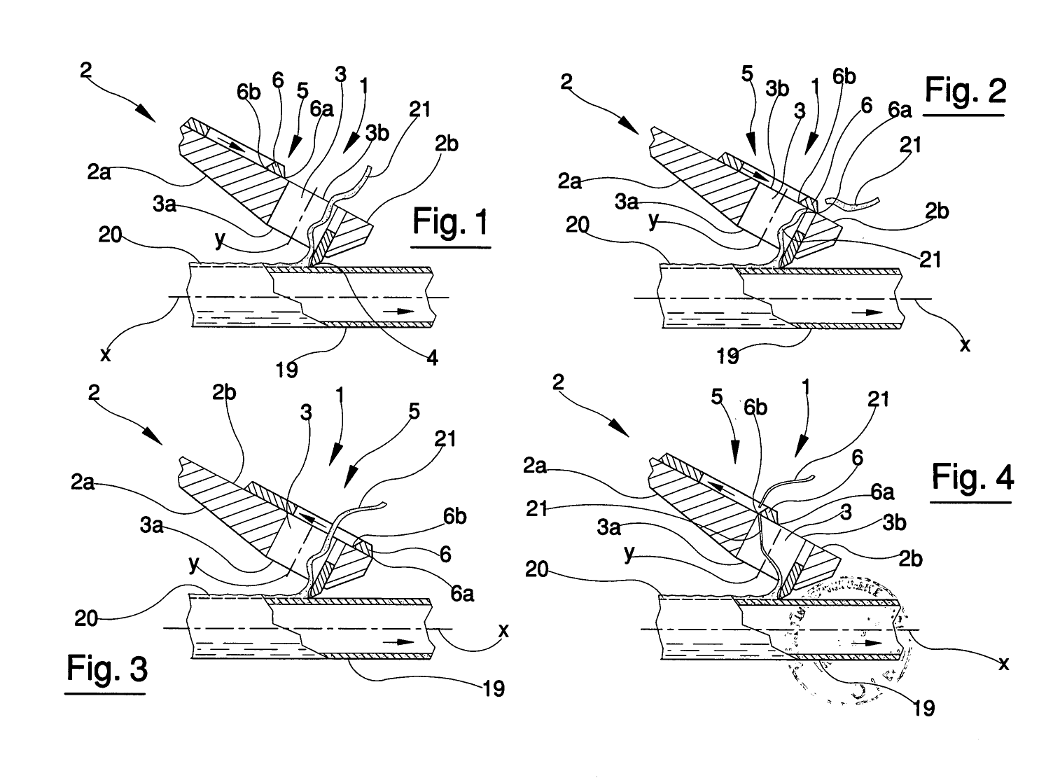

FIG. 1 is a schematic view in section of the tool of the invention in a first work stage;

FIG. 2 is the tool of FIG. 1 during a second work stage;

FIG. 3 is the tool of FIG. 1 during a third work stage;

FIG. 4 is the tool of FIG. 1 in a fourth work stage.

With reference to the figures of the drawings, 1 denotes in its entirety the tool of the present invention. It comprises a support 2 having at one end thereof a through-hole 3 which on an entrance edge 3a thereof bears a cutting element 4 arranged and conformed so as to remove, during a cutting motion, an external weld bead 20 and direct the resulting shaving 21 through the through-hole 3. The cutting motion is performed along a direction x which is parallel to the longitudinal axis of an element which longitudinally exhibits the external weld bead 20. In the illustrated embodiment, the support 2 is stationary while the element 19 is made to slide longitudinally. The support 2 exhibits a front surface 2a on which the edge of the entrance of the through-hole 3 is situated, and a rear surface 2b, on which an exit edge of the through-hole 3 is situated. As can be seen in the accompanying figures of the drawings, the support 2 is arranged so that the longitudinal axis y of the through-hole 3 forms a predetermined angle with respect to the direction x along which the cutting motion takes place. The cutting element 4 removes the bead 20 at a predetermined cutting angle and the removed shaving flows along the through-hole 3 up until it exits from the exit edge 3b.

Means 5 for chopping the shavings are provided in proximity of the exit edge 3b of the through hole 3, which means 5 for chopping fragment the shavings exiting from the through-hole 3. The means for chopping 5 comprise a blade 6 which exhibits a first cutting edge 6a and a second cutting edge 6b which is opposite the first cutting edge 6a. The blade 6 is slidable, during the cutting motion, on a surface containing the exit edge 3b of the through-hole 3 in an alternating motion. In the illustrated embodiment the blade 6 runs on the rear surface 2b of the support 2. During the alternating motion the blade 6 transits on the section of the through-hole 3, shuttling between a first “dead” point and a second dead point, arranged on opposite sides with respect to the through-hole 3, at which dead points the blade 6 is external of the exit edge 3b of the through-hole. The blade 6, in its alternating sliding motion, slides to and from over the area of the exit section of the through-hole.

The alternating motion of the blade 6 happens contemporaneously with the cutting motion. Assuming as a start point of the blade 6 the first dead point and considering a work run of the bead trimming of the bead to be constituted by the interval of time from when the first cutting edge 6a moves from the position assumed at the first dead point to when the first cutting edge 6a is in a position in which it completes its transit over the exit of the through-hole 3, the shaving 21 increases in length by an amount which is about equal to the product between the bead cutting speed and interval of time considered. By regulating the two operative parameters the shaving 21 can be made to project from the exit edge 3b of the through-hole 3 by a predetermined length. Thus, in the motion of the blade 6 from the first dead point to the second dead point at least a section of shaving 21, which is in movement through the through-hole 3, is caught between the first cutting edge 6a and at least a tract of the exit edge 3b of the through-hole 3, the shaving thus being cut at this section. The blade 6 concludes its run at the second dead point, at which it is external to the exit edge 3b of the through-hole 3. Similarly, in the motion of the blade 6 from the second dead point to the first dead point, during the time interval in which the second cutting edge 6b moves from the second dead point to the position at which it has completed its transit over the exit section of the through-hole 3, the shaving 21 increases in length by a measurement equal to about the product between the speed of cut of the bead 20 and the time interval considered. During this “return” run of the blade 6, at least a section of the shaving 21, which is still moving through the through-hole 3, is caught between the second cutting edge 6b and the exit edge of the through-hole 3 and is cut.

In the illustrated embodiment, the through-hole 3 is circular in section and the dead points of the alternating motion of the blade 6 are diametrically opposite with respect to the through-hole 3. The axes x, y and the sliding direction of the blade 6 are coplanar and lie on a vertical plane. As can be seen in FIGS. 2 and 4, the shaving 21 is cut at the diameter points of the exit edge 3b lying along the sliding direction of the blade 6. The blade 6 is associated to a support 6c, slidable on the rear surface 2b of the support 2, by two arms connected at ends thereof in such a way as to take the form of a guillotine. The two connection arms are of such a length and at such a distance so that the support 6c does not interfere with the through-hole 3.

By regulating the sliding speed of the blade 6 and the cutting speed of the bead 20, the length of the lengths of cut shaving 21 can be set to adapt them to the system of removal and disposal used on the production line.

The invention offers important advantages. Firstly, the shaving is reduced to a form which greatly simplifies its treatment and management. As it is chopped up into lengths, it can be collected in containers arranged in proximity of the bead-trimming machine and be removed therefrom automatically. The presence of an operative is thus needed only for control purposes, thus avoiding the particularly high risks connected with the manipulation of a dangerous shaving, which is very hot and might cut. The invention can also be adapted to suit any type of material and any set of working parameters, simply by regulating the frequency of the blade run.

1. An external bead trimmer with a shaving breaker device, wherein it comprises a support (2) having at an end thereof a through-hole (3) which bears, on an entrance edge thereof, a cutting element (4) arranged and conformed to remove, during a cutting motion, an external weld bead (20) and to direct a resulting shaving (21) through the through-hole (3), the through-hole (3) bearing, in proximity of an exit edge thereof, means for chopping (5) the shaving, predisposed to fragment the shaving coming from the through-hole (3).

2. The tool of claim 1, wherein the means for chopping (5) for fragmenting the shaving comprise a blade (6) having a first cutting edge (6a) and a second cutting edge (6b) opposite the first cutting edge (6a), the blade (6) being slidable, during a cutting motion, on a surface containing the exit edge of the through-hole (3) with an alternating motion in which the blade (6) transits over a section of the through-hole (3), moving between a first dead point and second dead point at which first and second dead points it is external of the through-hole (3).

3. The tool of claim 2, wherein in the motion of the blade (6) from the first dead point to the second dead point, at least a section of the shaving (21), which shaving (21) is moving through the through-hole (3), is caught between the first cutting edge (6a) and at least a tract of the exit edge of the through-hole (3), so that the shaving (21) is cut at the section thereof.

4. The tool of claim 2, wherein in the motion of the blade (6) from the second dead point to the first dead point at least a section of shaving (21), which is moving through the through-hole (3), is caught between the second cutting edge (6b) and at least a tract of the exit edge of the through-hole (3), so that the shaving (21) is cut at the section thereof.

5. The tool of claim 1, wherein the support (2) exhibits a front surface (2a) on which the entrance edge of the through-hole (3) is located, and a rear surface (2b) on which the exit edge of the through-hole (3) is located and on which the blade (6) runs.

6. The tool of claim 1, wherein the through-hole (3) is circular in section and the dead points of the alternating motion of the blade (6) are diametrically opposite with respect to the through-hole (3).

7. The tool of claim 2, wherein the blade (6) is associated to a support (6c) which is slidable on the rear surface (2b) of the support (2), by means of two arms connected at ends thereof, the arms being of a length and being arranged at a reciprocal distance from one another such that the support (6c) does not interfere with the through-hole (3).

8. The tool of claim 2, wherein the through-hole (3) is circular in section and the dead points of the alternating motion of the blade (6) are diametrically opposite with respect to the through-hole (3).
